(19) United States
(12) Patent Application Publication
(10) Pub. No.: US 2014/0119638 A1
(43) Pub. Date: May 1, 2014

(54) SYSTEM, METHOD AND COMPUTER PROGRAM PRODUCT TO EVALUATE A SEMICONDUCTOR WAFER FABRICATION PROCESS

(71) Applicant: TAIWAN SEMICONDUCTOR MANUFACTURING COMPANY, LTD., (US)

(72) Inventors: Feng-Ju Chang, Hsinchu City (TW); Lung-Yin Huang, Zhubei City (TW); Hung-Chun Wang, Ching-Shuei (TW); Chia-Chi Lin, Hsinchu City (TW); Ru-Gun Liu, Zhubei City (TW); Wen-Chun Huang, Tainan City (TW)

(73) Assignee: TAIWAN SEMICONDUCTOR MANUFACTURING COMPANY, LTD., Hsin-Chu (TW)

(21) Appl. No.: 13/665,996

(22) Filed: Nov. 1, 2012

(51) Int. Cl. G06T 7/00

(52) U.S. Cl. CPC G06T 7/001
USPC 382/151

(57) ABSTRACT

Systems, methods and computer program products for computerized evaluation of a semiconductor wafer fabrication process are described. An exemplary method comprises receiving an SEM image of a printed semiconductor wafer area and a reference image reflecting a circuit design pattern, enhancing the SEM image to produce a feature image, and comparing the feature image to the reference image to determine whether the positions of the images are the same. Based upon this analysis, evaluation of the fabrication process used to print the circuit on the SEM image can be conducted in an efficient and uniform manner.

### BACKGROUND

During evaluation of semiconductor fabrication processes, it must be determined whether desired circuitry can be printed on certain portions of the wafer area. Traditionally, in order to determine this, a scanning electron microscope (“SEM”) is used to take a picture of a small fraction of a printed wafer area, which is then evaluated to make the determination. As such, it is critically important that the SEM image be captured at the correct position so that the correct wafer area dimension can be evaluated.

After the image is taken, it is then visually inspected to determine if it was captured at the correct position. To make this determination, the engineers must review a reference pattern reflecting the original design of the wafer area. This reference pattern is then visually compared to the actual SEM image, also containing the circuit pattern, to determine if the position of the SEM image is the same as the position of the reference pattern image along the wafer. If it is determined that the SEM image was not taken at the correct position, the image is discarded, the SEM is manually calibrated, and/or the image is taken again. Once it is determined the SEM image was taken in the correct position, the SEM image is then visually inspected for defects and measured to determine if its dimensions are sufficient to print the desired circuitry thereon. If so, the production process is vetted and production using the process can begin.

There are a variety of disadvantages associated with the conventional determination of the SEM image position. Naturally, being that the positional determination is conducted manually through visual inspection, it is highly susceptible to error and non-uniformity. For example, the judgments of personnel reviewing the SEM images are highly subjective and, thus, the evaluations will vary wafer to wafer. Also, the calibration process is tedious and time consuming. Accordingly, on average it takes about 1.5 days to make the positional determination, so the process can be very time consuming, thus adding further costs to the overall semiconductor fabrication process.

### BRIEF DESCRIPTION OF THE DRAWINGS

The present disclosure is best understood from the following detailed description when read in conjunction with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is a block diagram of an exemplary wafer image classification system according to an exemplary embodiment of the present invention;

FIG. 2A is a block diagram of a wafer image classification module according to an exemplary embodiment of the present invention;

FIG. 2B illustrates an SEM image taken in accordance to an exemplary methodology of the present invention;

FIG. 2C illustrates an overlay image taken in accordance to an exemplary methodology of the present invention;

FIG. 2D illustrates a reference image extracted from the overlap image that reflects a design layout of a semiconductor wafer in accordance to an exemplary methodology of the present invention; and

FIG. 3 is a flow chart of a method for evaluating a wafer fabrication process according to an exemplary methodology of the present invention.

### DETAILED DESCRIPTION

Illustrative embodiments and related methodologies of the present invention are described below as they might be employed in a system to evaluate a wafer fabrication process. In the interest of clarity, not all features of an actual implementation or methodology are described in this specification. It will of course be appreciated that in the development of any such actual embodiment, numerous implementation specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

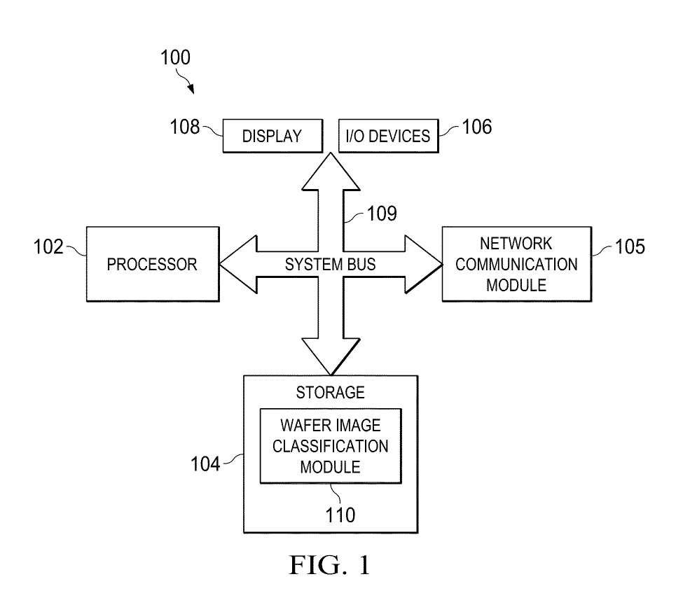

FIG. 1 shows a block diagram of wafer image classification system 100 according to an exemplary embodiment of the present invention. In one embodiment, wafer image classification system 100 includes at least one processor 102, a non-transitory, computer-readable storage 104, transceiver/network communication module 105, optional I/O devices 106, and an optional display 108, all interconnected via a system bus 109. Software instructions executable by the processor 102 for implementing software instructions stored within wafer classification module 110 in accordance with the exemplary embodiments described herein, may be stored in storage 104 or some other computer-readable medium.

Although not explicitly shown in FIG. 1, it will be recognized that wafer image classification system 100 may be connected to one or more public and/or private networks via appropriate network connections. It will also be recognized that the software instructions comprising wafer image classification module 110 may also be loaded into storage 104 from a CD-ROM or other appropriate storage media via wired or wireless methodologies.

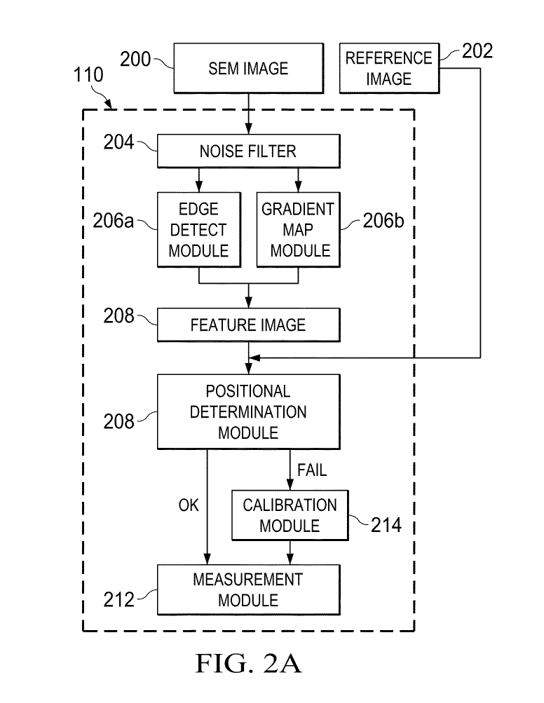

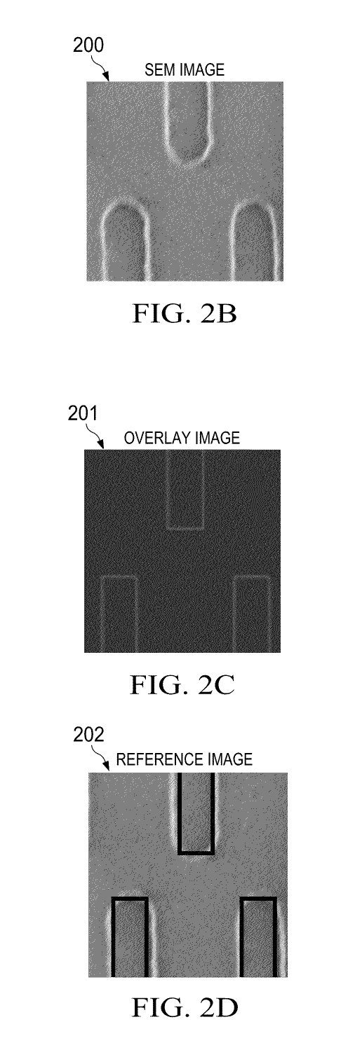

FIG. 2A illustrates a block diagram of the architecture of wafer image classification module 110 according to an exemplary embodiment of the present invention. First, an SEM image 200 is introduced into wafer image classification system 100 via I/O device 106, storage 104, etc., or from some remote server location, as would be understood by one ordinarily skilled in the art having the benefit of this disclosure. When the SEM images are taken, each contains an entire wafer design layout—from which a magnified image will be utilized as the SEM image 200 (FIG. 2B). Thereafter, processor 102 instructs wafer image classification system 100 to transmit SEM image 200 to wafer classification module 110. An overlay image 201 (FIG. 2C) is overlaid atop SEM image 200 by wafer image classification system 100. Thereafter, a reference image 202 (FIG. 2D) is extracted from overlap image reflecting a predetermined area of the wafer design is also introduced into wafer classification system 100 and transmitted to wafer image classification module 110 in like manner.

FIGS. 2B-2D illustrate an exemplary SEM image 200, overlay image 201 and reference image 202 for the semiconductor wafer, respectively. As described below, exemplary embodiments of the present invention are utilized to reduce wafer review time and set an optimal review standard by first determining if the position of the SEM images were the same for both SEM image 200 (FIG. 2B) and reference image 202 (FIG. 2D), and then determining the critical dimensions of SEM image 200. Thereafter, processor 102 transmits SEM image 200 to a noise filter 204 where SEM image 200 is blurred using, for example, a Gaussian blur function for image processing, as would be understood by one ordinarily skilled in the art having the benefit of this disclosure.

Processor 102 then communicates the noised filtered SEM image 202 to an edge detection module 206a which converts SEM image 200 into a digitally enhanced SEM image. In this exemplary embodiment, SEM image 200 is an analog image comprising grey scaled pixels. Reference image 202, however, is a digital image reflecting only black and white pixels. Therefore, via the use of certain threshold values used to assign a “1” or “0” bit for each pixel within the image, the analog SEM image 200 can be digitized. For example, if a threshold value of 0.5 was set, those pixels which processor 102 determines to have a value of 0.4 would be assigned a 0 value, while those having a 0.6 value would be assigned a 1. Here, a 1 refers to a white pixel and a 0 refers to a black pixel. As a result, the grey scaled SEM image 200 is now converted to a digitally enhanced SEM image 200. Thereafter, utilizing edge detection module 206a, processor 102 determines where the edges of SEM image 200 are located by detecting where the pixel values change from 0 to 1 or vice versa. In the alternative, however, the noise filtered SEM image 200 may instead be transmitted to a gradient map module 206b which detects a certain threshold intensity change of the image pixels to determine the edge of SEM image 200. Those ordinarily skilled in the art having the benefit of this disclosure realize there are other ways in which to enhance and detect various features of the original SEM image 200, and such methodologies are within view of the present disclosure.

Still referring to FIG. 2A, utilizing wafer image classification module 110, processor 102 outputs a feature image 208, which is the digitally enhanced version of SEM image 200 of the semiconductor wafer. However, those ordinarily skilled in the art having the benefit of this disclosure realize that analog enhancement methodologies may also be utilized. Nevertheless, processor 102 the compares feature image 208 to the reference image 202 in order to determine if feature image 208 SEM was taken at the same position as reference image 202. To conduct the comparison of this exemplary methodology, processor 102 proceeds to initiate the algorithm embodied in a positional determination module 210. Here, in this exemplary embodiment, processor 102 analyzes the pixels of the two images and, based upon a predetermined threshold value, determines if the pixels are similar enough to output a match. For example, processor 102 may define a suitable search area within each image to be, for example, a 20×20 pixel area. Thereafter, if feature image 208 and reference image 202 has corresponding white pixels (value of 1) near all vertical lines within the search area (or at its pixel coordinate), processor 102 would determine the feature image 208 and reference image 202 were similar enough. Those ordinarily skilled in the art having the benefit of this disclosure realize there are a variety of additional ways in which to analyze and compare the feature and reference images to determine a match, and such methodologies are within view of the present disclosure.

If processor 102 determines the positions of feature image 208 and reference image 202 are the same, the algorithm continues on to measurement module 212 where processor 102 determines the dimensions of feature image 208 (when the magnification (for SEM image 200) is set, the dimensions of SEM image 200 and overlay image 201 are defined). Once the dimensions are determined, processor 102 can output the dimensions via display 108 or as a printed report, for example. Thereafter, the dimensional data can be analyzed to determine if it meets the critical dimensions necessary to print the circuitry contained in the reference image. If the dimensions are sufficient, the fabrication process (which was used to print the circuit reflected in feature image 208) has been validated. However, if the dimensions are not sufficient, the fabrication process is found insufficient for fabrication.

However, referring back to positional determination module 210, if processor 102 determines that the positions were not the same for feature image 208 and reference image 202, a failure occurs and the algorithm will proceed to calibration module 214. Here, processor 102 determines whether feature image 208 and reference image 202 are similar enough to simply recalibrate feature image 208 by manipulating its position. To accomplish this, as previously described, processor 102 may define a suitable search area within each image to be, for example, a 20×20 pixel area. Thereafter, if feature image 208 and reference image 202 has corresponding white pixels (value of 1) within the search area at its pixel coordinate, processor 102 would determine the feature image 208 and reference image 202 were similar enough. However, those ordinarily skilled in the art having the benefit of this disclosure realize there are other methods by which to determine a match between the images.

Thereafter, to manipulate the position of feature image 208 if necessary, processor 102 may utilize an image manipulation algorithm that centers feature image 208 or moves it to the right in order to match reference image 202. As would be readily understood by those ordinarily skilled in the art having the benefit of this disclosure, there are a variety of such image manipulation algorithms which may be used, and such methodologies are within view of the present disclosure.

In other exemplary embodiments, the SEM itself may need to be calibrated and SEM image 200 captured again. Nevertheless, after feature image 208 has been calibrated or SEM image 200 retaken, processor 102 initiates the algorithm of measurement module 212 in order to determine if the dimensions of feature image 208 are sufficient to print the desired circuit layout. If processor 102 determines feature image 208 meets the critical dimensions, the fabrication process has been validated. If, however, processor 102 determines feature image 208 fails to meet the critical dimensions, the fabrication process is found to be insufficient for manufacturing that specific circuit design.

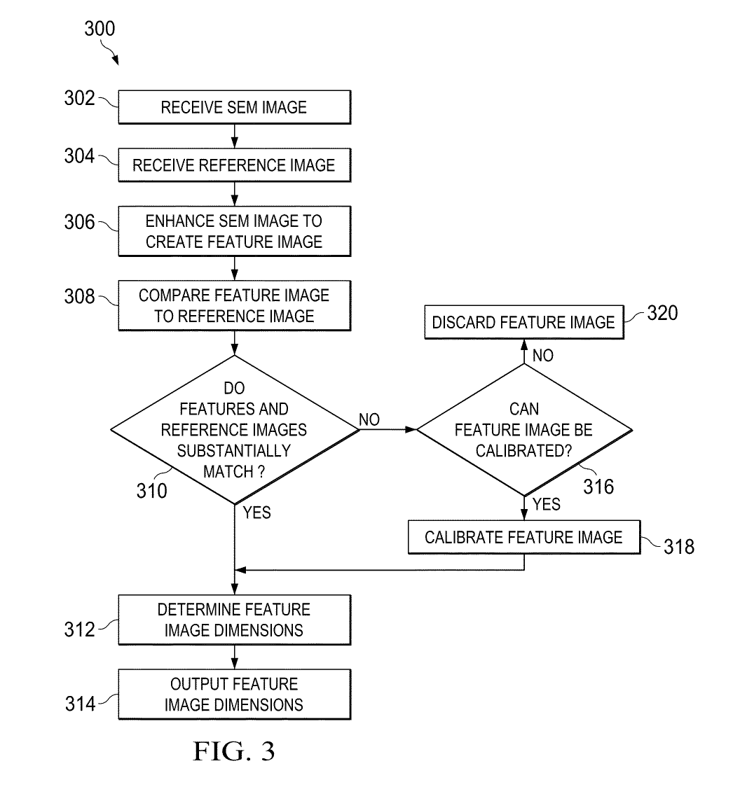

FIG. 3 is a flow chart illustrating steps in an exemplary method 300 for evaluating a semiconductor wafer fabrication process. At step 302, processor 102 receives SEM image 200 via I/O devices 106, storage 104 or some remote location. At step 304, processor 304 also receives reference image 202 in a similar way. At step 306, processor 102 enhances SEM image 200 to a higher resolution. As previously described, such enhancement may take the form of digital enhancement.

Nevertheless, the resultant enhanced image is output as feature image 208. At step 308, processor 102 then compares feature image 208 to reference image 202 to determine if the positions of the images substantially match. As previously described, it is not necessary that the images match precisely, as a threshold matching algorithm may be utilized. If, at step 312, processor 102 determines the images do match, processor 102 then determines the dimensions of feature image 208. Thereafter, at step 314, the dimensions of feature image 208 are output.

If, however, at step 310, processor 102 determines feature image 208 and reference image 202 do not match, the algorithm continues on to step 316 where processor 102 determines if feature image 208 can be calibrated. As previously described, such a determination can be made using image recognition software that compares feature image 208 to reference image 202 to assign a value reflecting the discrepancies in the images (e.g., based upon pixel analysis). Using some predetermined threshold, processor 102 can then determine if feature image 208 can be calibrated at step 318, or whether feature image 208 must be discarded at step 320. If feature image 208 is calibrated, processor 102 then continues on to step 213, as illustrated.

Once the dimensions of feature image 314 are output, it can be determined whether the fabrication process used to print the circuit of feature image 208 is sufficient for production. In one exemplary methodology, this determination is made manually. However, in an alternative methodology, this determination is made by wafer image classification system 100. Thereafter, the vetted fabrication processes is then utilized to produce semiconductor wafers accordingly.

Accordingly, exemplary embodiments and methodologies of the present invention provide a uniform standard for analyzing SEM images in order to evaluate wafer fabrication processes, thus resulting in a highly efficient and cost-effective overall fabrication process. For example, the present invention can make a positional determination of an SEM image in as little as 19 minutes, as opposed to the 1.5 day determination period of prior art methods. Therefore, utilizing the present invention, the efficiency of the engineering side of wafer fabrication is increased which, in turn, greatly increases the productivity and profitability of the overall semiconductor fabrication process.

An exemplary methodology of the present invention provides a computer-implemented method to evaluate a semiconductor fabrication process. The method comprises receiving a scanning electron microscope (“SEM”) image corresponding to an area of a semiconductor wafer, receiving a reference image corresponding to a design pattern of an area of a semiconductor wafer, and image enhancing the SEM image, thereby producing a feature image. The method goes on to also compare the feature image to the reference image in order to determine if a position of the feature image and a position of the reference image are substantially similar. This comparison is then utilized to evaluate the semiconductor fabrication process.

An exemplary embodiment of the present invention provides a system having processing circuitry to evaluate a semiconductor fabrication process. The processing circuitry performs a method comprising receiving a scanning electron microscope (“SEM”) image corresponding to an area of a semiconductor wafer, receiving a reference image corresponding to a design pattern of an area of a semiconductor wafer, and image enhancing the SEM image, thereby producing a feature image. The method goes on to compare the feature image to the reference image in order to determine if a position of the feature image and a position of the reference image are substantially similar, wherein the comparison is utilized to evaluate the semiconductor fabrication process.

Yet another exemplary embodiment of the present invention provides a computer program product. The program product has instructions stored thereon which, when executed by the processor, causes the processor to perform a method comprising receiving a scanning electron microscope (“SEM”) image corresponding to an area of a semiconductor wafer, receiving a reference image corresponding to a design pattern of an area of a semiconductor wafer, image enhancing the SEM image, thereby producing a feature image, and comparing the feature image to the reference image in order to determine if a position of the feature image and a position of the reference image are substantially similar, wherein the comparison is utilized to evaluate the semiconductor fabrication process.

The foregoing outlines features of several embodiments so that those ordinarily skilled in the art may better understand the aspects of the present disclosure. Those skilled persons should appreciate that they may readily use the present disclosure as a basis for designing or modifying other processes and structures for carrying out the same purposes and/or achieving the same advantages of the embodiments and methodologies introduced herein. For example, although described herein as sequential steps in exemplary methodologies, those ordinarily skilled persons would realize that certain steps may be altered and varied as desired. As such, those same skilled persons should also realize that such equivalent constructions do not depart from the spirit and scope of the present disclosure, and that they may make various changes, substitutions, and alterations herein without departing from the spirit and scope of the present disclosure. Therefore, it should be understood that the invention is not intended to be limited to the particular forms disclosed. Rather, the intention is to cover all modifications, equivalents, and alternatives falling within the spirit and scope of the invention as defined by the appended claims.

What is claimed is:

1. A computer-implemented method to evaluate a semiconductor fabrication process, the method comprising:
receiving a scanning electron microscope (“SEM”) image corresponding to an area of a semiconductor wafer;
receiving a reference image corresponding to a design pattern of an area of a semiconductor wafer;
image enhancing the SEM image, thereby producing a feature image; and
comparing the feature image to the reference image in order to determine if a position of the feature image and a position of the reference image are substantially similar, wherein the comparison is utilized to evaluate the semiconductor fabrication process.

2. A computer-implemented method as defined in claim 1, further comprising determining dimensions of the feature image, wherein the determination of the dimensions of the feature image is also utilized to evaluate the semiconductor fabrication process.

3. A computer-implemented method as defined in claim 1, wherein image enhancing the SEM image to produce the feature image comprises digitally enhancing the SEM image.

4. A computer-implemented method as defined in claim 1, wherein comparing the feature image to the reference image further comprises calibrating the feature image if the position of the feature image is not substantially similar to the position of the reference image.

5. A computer-implemented method as defined in claim 2, further comprising determining whether the semiconductor fabrication process is viable based upon the determination of the dimensions of the feature image.

6. A system comprising processing circuitry to evaluate a semiconductor fabrication process, the processing circuitry performing the method comprising:
receiving a scanning electron microscope (“SEM”) image corresponding to an area of a semiconductor wafer;
receiving a reference image corresponding to a design pattern of an area of a semiconductor wafer;
image enhancing the SEM image, thereby producing a feature image; and
comparing the feature image to the reference image in order to determine if a position of the feature image and a position of the reference image are substantially similar, wherein the comparison is utilized to evaluate the semiconductor fabrication process.

7. A system as defined in claim 6, the circuitry further performing the method of determining dimensions of the feature image, wherein the determination of the dimensions of the feature image is also utilized to evaluate the semiconductor fabrication process.

8. A system as defined in claim 6, wherein image enhancing the SEM image to produce the feature image comprises digitally enhancing the SEM image.

9. A system as defined in claim 6, wherein comparing the feature image to the reference image further comprises calibrating the feature image if the position of the feature image is not substantially similar to the position of the reference image.

10. A system as defined in claim 7, the circuitry further performing the method of determining whether the semiconductor fabrication process is viable based upon the determination of the dimensions of the feature image.

11. A computer program product comprising instructions which, when executed by at least one processor, causes the processor to perform a method comprising:
receiving a scanning electron microscope (“SEM”) image corresponding to an area of a semiconductor wafer;
receiving a reference image corresponding to a design pattern of an area of a semiconductor wafer;
image enhancing the SEM image, thereby producing a feature image; and
comparing the feature image to the reference image in order to determine if a position of the feature image and a position of the reference image are substantially similar, wherein the comparison is utilized to evaluate the semiconductor fabrication process.

12. A computer program product as defined in claim 11, further comprising determining dimensions of the feature image, wherein the determination of the dimensions of the feature image is also utilized to evaluate the semiconductor fabrication process.

13. A computer program product as defined in claim 11, wherein image enhancing the SEM image to produce the feature image comprises digitally enhancing the SEM image.

14. A computer program product as defined in claim 11, wherein comparing the feature image to the reference image further comprises calibrating the feature image if the position of the feature image is not substantially similar to the position of the reference image.

15. A computer program product as defined in claim 12, further comprising determining whether the semiconductor fabrication process is viable based upon the determination of the dimensions of the feature image.
